(19) United States
(12) Patent Application Publication
(10) Pub. No.: US 2021/0334886 A1
(43) Pub. Date: Oct. 28, 2021

(54) USER-DEFINED PERSONALIZATION OF DYNAMICALLY RANKED CONTENT

(71) Applicant: Amazon Technologies, Inc., Seattle, WA (US)

(72) Inventors: Jason Roy Clark, Lake Forest, CA (US); Feroz Abdul Kadar, Irvine, CA (US)

(21) Appl. No.: 16/855,344

(22) Filed: Apr. 22, 2020

(51) Int. Cl. G06Q 30/06; G06F 9/451; G06F 16/9535; G06F 16/2457; G06F 16/9538; G06F 3/0482

(52) U.S. Cl. CPC G06Q 30/0641; G06F 9/451; G06F 16/9535; G06F 3/0482; G06F 16/9538; G06Q 30/0633; G06F 16/24578

(57) ABSTRACT

Disclosed are various embodiments for providing a unique user experience for a user account interacting with an electronic commerce site by dynamically generating content that is organized and presented according to a strategy and/or a user context for a given shopping experience and allowing the user associated with the user account to rearrange the ordering of the displayed content. A user interacting with the electronic commerce system can be provided an interactive experience that is uniquely tailored for a specific user account according to type and arrangement of the content that is presented to each user associated with the user account. The user can further rearrange and/or specify the positioning of the content via user interactions (e.g., pinning a user interface element to indicate a preferred position, dragging a user interface element to a different location on a user interface, etc.).

### BACKGROUND

An electronic commerce system may include listings of items (e.g., products, goods, services, digital content, etc.) offered for sale, lease, download, rent, etc., by many different merchants. Users may use the electronic commerce system to purchase, lease, download, rent, etc., items of interest.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1C are pictorial diagrams of example user interfaces illustrating examples of content being organized for a user account according to various embodiments of the present disclosure.

FIG. 2 is a schematic block diagram of a networked environment according to various embodiments of the present disclosure.

FIGS. 3A-3B are pictorial diagrams of example user interfaces rendered by a client device in the networked environment of FIG. 2 according to various embodiments of the present disclosure.

FIGS. 4 and 5 are flowcharts illustrating examples of functionality implemented as portions of an electronic commerce application and a content selection engine executed in a computing environment in the networked environment of FIG. 2 according to various embodiments of the present disclosure.

FIG. 6 is a flowchart illustrating one example of functionality implemented as a portion of a client application executed in a client device in the networked environment of FIG. 2 according to various embodiments of the present disclosure.

FIG. 7 is a schematic block diagram that provides one example illustration of a computing environment employed in the networked environment of FIG. 2 according to various embodiments of the present disclosure.

### DETAILED DESCRIPTION

The present disclosure relates to providing a unique user experience for a user account interacting with an electronic commerce site by dynamically generating content that is organized and presented according to a strategy and/or a user context for a given shopping experience. In addition, the present disclosure allows the user associated with the user account to rearrange the ordering of the displayed content. For example, a user associated with a user account can be presented with one or more grouping of items (e.g., products, goods, services, digital content, etc.) that are ranked and presented to the user according to various strategies and/or the user context such that the user is presented with content that is most relevant and/or determined to be of interest to the particular user account. According to various embodiments, user accounts interacting with the electronic commerce system can each be provided a different interactive experience that is uniquely tailored for a specific user account according to type and arrangement of the content that is presented to each user associated with the user account. The user is provided additional control over his or her experience by being able to personalize the positioning of the content via user interactions with the content (e.g., pinning a user interface element to indicate a preferred position, dragging a user interface element to a different location on a user interface, etc.).

According to various embodiments, items can be presented to a user through the use of aisles. An aisle is a dynamically generated grouping of items. For example, similar to a grocery store where different items are arranged in different grocery aisles, the aisles presented to the user via a user interface may include items associated with a particular item category (e.g., beverages, dairy, produce, etc.). In some examples, an aisle may also include items that are not included in a given item category but are determined to be included in the grouping of items according to other factors (e.g., complementary items, items on sale, etc.). According to various embodiments, the selection and arrangement of items within an aisle can be determined according to a user context, selected strategies, and/or a user-specified position. In some embodiments, the arrangement of the aisles as well as other types of content (e.g., advertisements, vendor provided content, recommendations, etc.) can be determined according to the user content, selected strategies, and/or user-specified positions, thereby providing the user with a unique shopping experience that is tailored to his or her determined interest for a given user context.

A user context can be based on a variety of factors including, for example, store brand, store type (e.g., physical vs. online), location, region, user eligibility status (e.g., membership status, included in an invite-only list, etc.), current store section (e.g., what product categories or aisle is the user currently browsing), type of page the customer is viewing (e.g., item detail page, store front page, search result page, etc.), user interaction history (e.g., purchase history, browsing history, viewing history, search history, rating history, etc.), interaction behavior during an active shopping experience (e.g., searching behavior, browsing behavior, and add to cart behavior), aggregate interaction behavior (e.g., multiple user interaction behavior), item availability (e.g., inventory, delivery capacity), event notice (e.g., emergency, road closure, etc.), time (e.g., date, year, week, day), seasonality, a predefined list of items associated with a user account, one or more user-specified content positions, and/or other factors. According to various embodiments, an analysis of these factors can be used to determine a user context that can define an interactive experience for a user during a given shopping experience. For example, the user context can be used for the selection of items, the arrangement of the items, the arrangement of aisles, the arrangement of additional content, the selection of strategies, and/or other actions required to uniquely tailor a shopping experience for a user account.

In addition to the user context, various strategies can be used to organize and present personalized content associated with a user account during a given shopping experience. As such, strategy-based selection of items and arrangement of content can provide a user account with a personalized and unique interactive experience that is tailored to the determined interest of the user associated with the particular user account. A strategy can include a specific approach for selecting items or other types of content to present to the user associated with the user account at a given time. According to various examples, a strategy may correspond to a characteristic associated with items available for purchase, lease, rent, download, etc., via interactions with the electronic commerce system. The characteristics may include, for example, past purchases, trending items, items on sale, advertisements, popular items, complementary items, and/or other type of item characteristics or strategy as can be appreciated. When selecting items to present to a customer based on a given strategy, only those items that correspond to the strategy will be selected. For example, when the strategy is based on “trending items,” only those items that are currently trending will be selected.

According to various examples, different types of strategies can be selected and ranked according to the user context. For example, a user account may be known to be interested in past purchases but is known not to interact much with advertisements. As such, the types of strategies can be ranked and presented to the user such that the items associated with the more relevant strategies are presented to the user prior to the presentation of items associated with the least relevant strategies. In some examples, the user can be presented with an aisle (e.g., a grouping of items) that includes items that are organized according to a given strategy.

According to various embodiments, a user interface containing various content (e.g., aisles) can be configured such that a user interacting with the user interface can modify and/or specify a preferred positioning of the content within the user interface layout. For example, a user interface can be generated and presented to a user account such that different aisles are arranged according to a ranking of aisles based at least in part on the user context and/or other strategies. According to various embodiments, the user can further personalize the arrangement of content by specifying that a particular aisle remains in a static position (e.g., always keep Aisle 2 in the second slot), requesting that a particular aisle be included in a designated display region (e.g., display region designated for select aisles), dragging a particular aisle above or below other aisles to reorder the positioning, and/or other types of interactions that can allow the user control to define a preferred arrangement of different aisles. As the user interface updates (e.g., refreshes, begins new session, etc.) and the content to be displayed is re-ranked according to a change in user context and/or strategies, the content associated with a user-defined positioning will continue to be presented as defined by the user, thereby superseding the generated ranking of content. In various embodiments, a user-defined positioning for particular content can further be used when determining user context and/or selecting strategies.

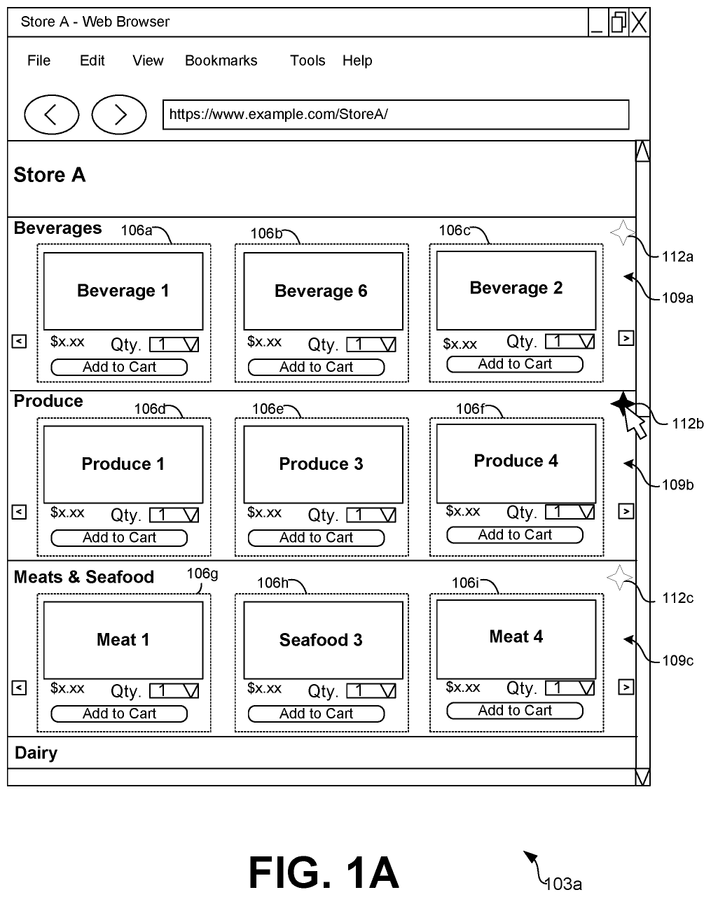

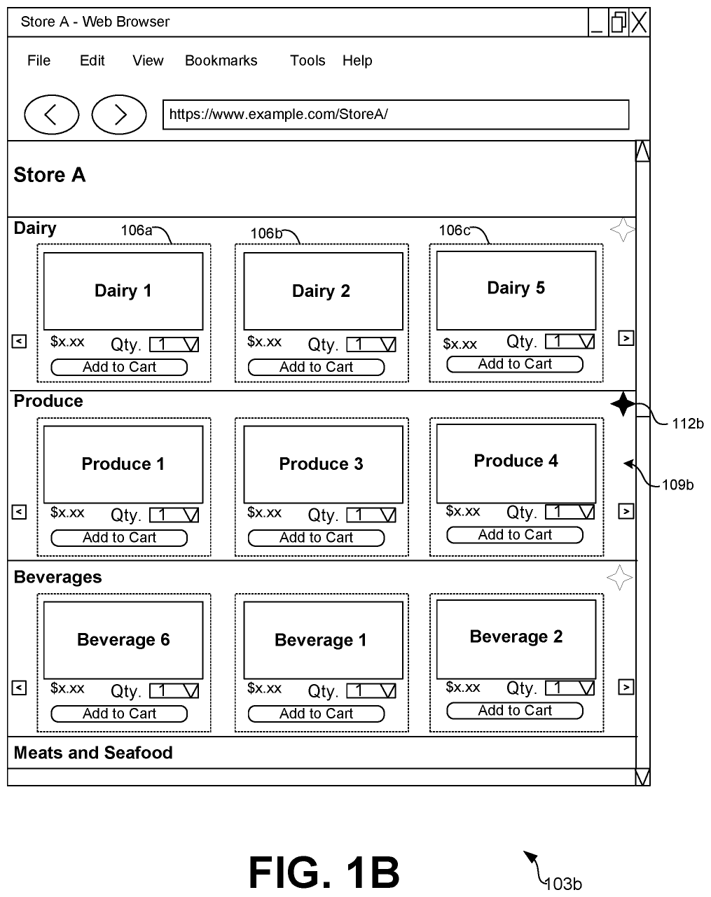

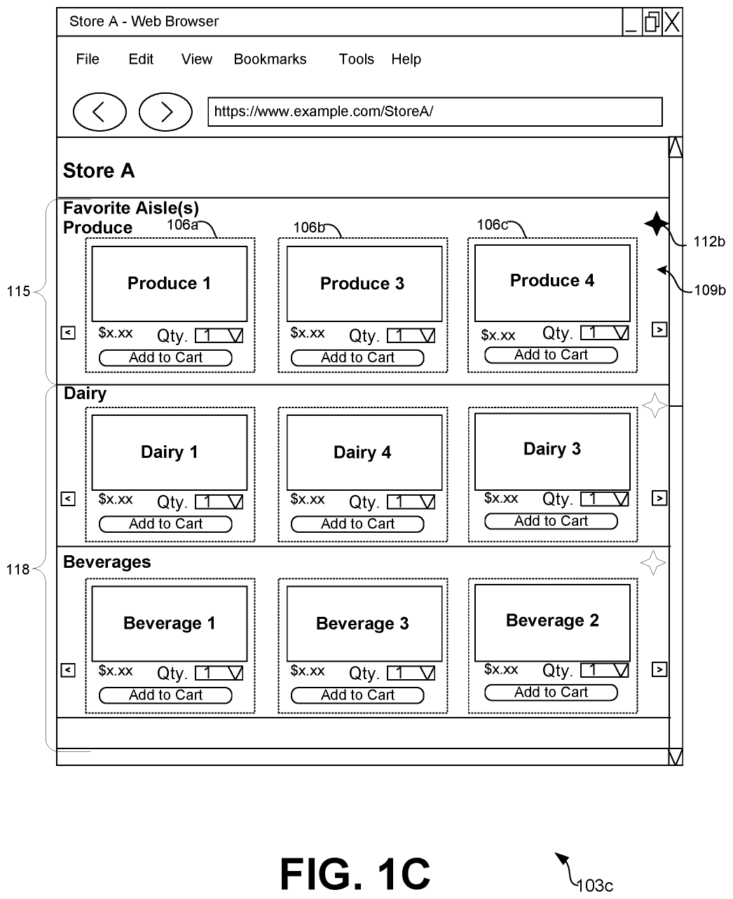

Turning now to FIG. 1A, shown is an example user interface 103a that includes item listings (e.g., 106a, 106b, 106c, 106d, 106e, 106f, 106g, 106h, 106i) arranged in aisles 109 (e.g., 109a, 109b, 109c) to allow a user to browse through items that are available for purchase, lease, rent, download, etc., according to various embodiments of the present disclosure. The user interface 103 can correspond to an item detail page, a search results page, a store landing page, an aisle landing page, and/or other type of page associated with an electronic commerce site that includes listings of items available via the electronic commerce application. According to various examples, the user interface 103 can comprise consecutively positioned display regions, or “slots,” that are associated with one or more aisles 109. The slots can be arranged in a horizontal or vertical configurations.

The item listings 106 can correspond to items (e.g., products, goods, services, digital content, etc.) that are determined to be relevant and/or of interest to the user according to the user context and/or strategies. An item listing can comprise an item image, an item price, an add-to-cart component, a one-click purchase component (not shown), a select quantity component, an item name, and/or other item attribute or selectable component as can be appreciated. In some embodiments, the item listings 106 can comprise a selectable region, that in response to user interaction (e.g., selection, hover action, etc.), can be configured to redirect the user to a user interface that provides additional information about the given product. In some examples, a user interaction with the selectable region can generate a pop-up box or other user interface element (e.g., drop down box, inline expansion component, etc.) that can be generated and presented to the user with additional information about the item without redirecting the user to a different network page or other user interface 103.

As shown in FIG. 1A, each aisle 109 comprises a selectable component 112 (e.g., 112a, 112b, 112c) that, upon selection, indicates that the user account has requested that the aisle 109 be positioned in a particular location in the user interface 103. As such, upon a refresh of the user interface 103, a generation of a new type of user interface 103, an occurrence of another interaction session between the user account and the electronic commerce site, and/or other action that requires a modification of the user interface 103, the aisle 109 will be positioned at the user-defined location in the user interface 103 regardless of the ranking of the aisle 109 with respect to other aisles 109.

In some examples, a selection of the selectable component 112 can indicate a request for the aisle 109 to remain at a static position in the user interface 103, thereby pinning the aisle 109 to same position each time the user interface 103 or type of user interface 103 is presented to the user account. An example of this embodiment is shown in FIG. 1B. FIG. 1B illustrates a user interface 103b that is presented to the user account following user interactions with the user interface 103a of FIG. 1A according to various embodiments. The user interface 103b of FIG. 1B may correspond to a refresh of the user interface 103a, a generation of a new type of user interface 103, an occurrence of another interaction session between the user account and the electronic commerce site, and/or other action that requires a modification of the user interface 103a of FIG. 1A.

FIG. 1A illustrates a user selection of the selectable component 112b for the aisle 109b corresponding to “Produce.” According to the dynamic ranking of aisles 109 that is based on the user context and/or strategies, the aisle 109b for “Produce’ is determined to be in the second “slot” of the user interface 103. As shown in FIG. 1B, the aisle 109b for “Produce” remains at the second “slot” of the user interface 103b while the other aisles 109 (e.g., Dairy, Beverages) are arranged in positions that are different from the positions of the same aisles 109 in the user interface 103a of FIG. 1A.

For example, based on a change of the user context and/or one or more strategies, the ranking of aisles 109 associated with the display of FIG. 1B can change from the ranking of aisles 109 displayed in FIG. 1A. In this example, assume that in the updated ranking of aisles 109, the aisle 109b for “Produce” was ranked fifth. However, instead of being positioned in the fifth consecutive “slot” of the user interface 103, the aisle 109b for “Produce” remains at the second position as specified by the selection of the selectable component 112b. Upon deselection of the selectable component 112, the aisle 109b for “Produce” will no longer be static and will be arranged according to the dynamic ranking of aisles 109 based at least in part on the user context and/or strategies.

In some examples, a selection of the selectable component 112 indicates that the user account requests that the aisle 109 be included in a display region 115 (FIG. 1C) or user interface panel that is designated for aisles 109 where the corresponding selectable components 112 are selected. FIG. 1C illustrates an example user interface 103 that includes a first display region 115 designated for the selectable component 112b of the aisle 109b that has been selected in FIG. 1A and at least one second display region 118 designated for the aisles 109 that have not been selected by the user account. As shown in FIG. 1C, the first display region 115 may be designated for favorite aisles 109 or otherwise selected aisles 109. Although shown at the top of the user interface 103c in FIG. 1C, the first display region 115 designated to include the aisles 109 with selectable components 112 that have been selected can be located at the top, bottom, side, or middle of the user interface 103 as can be appreciated.

As one skilled in the art will appreciate in light of this disclosure, certain embodiments may be capable of achieving certain advantages, including some or all of the following: (1) reducing computer resource utilization (e.g., memory consumption, processor utilization, network transfer, etc.) by avoiding the need to individually search an online catalog for items of interest; (2) improving the user experience in interacting with a computer system by automatically identifying content of interest to the user and allowing the user control over his or her experience, so the user does not waste his or her time ending up at dead-ends without finding desired items; (3) improving the functioning of the computing system through a more streamlined purchasing process that reduces user frustration when searching for other items; (4) improving the user experience in interacting with a computer system by providing a dynamically generated user interface with a unique layout tailored to the interests of the user to allow the user to easily access relevant items for a given context; and so forth. In the following discussion, a general description of the system and its components is provided, followed by a discussion of the operation of the same.

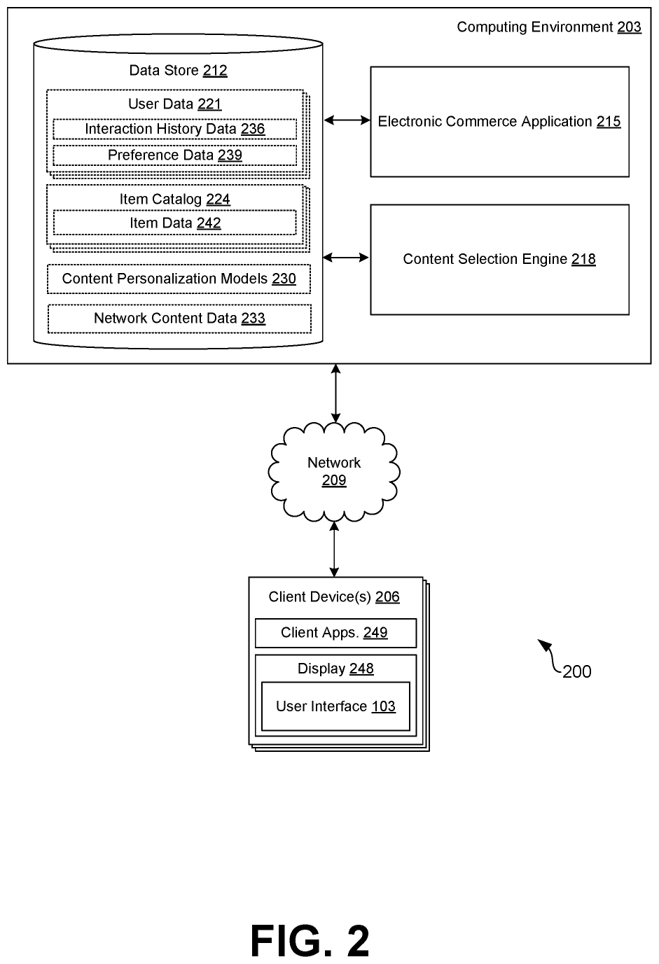

With reference to FIG. 2, shown is a networked environment 200 according to various embodiments. The networked environment 200 includes a computing environment 203 and a client device(s) 206, which are in data communication with each other via a network 209. The network 209 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include the electronic commerce application 215, the content selection engine 218, and other applications, services, processes, systems, engines, or functionality not discussed in detail herein. The electronic commerce application 215 is executed to facilitate the online sale, download, lease, rent, etc. of items from one or more electronic commerce systems over the network 209. Such items may include products, goods, services, digital content, and/or other items. The electronic commerce application 215 also performs various backend functions associated with the online presence of an electronic commerce system in order to facilitate the online purchase of items. For example, the electronic commerce application 215 generates network pages such as, for example, web pages and/or other types of network content that are provided to client devices 206 for the purposes of promoting and selecting items for purchase, rental, download, lease, or any other forms of consumption.

The content selection engine 218 is executed to determine a user context for a user account during a given shopping experience via interactions with the electronic commerce application 215. In addition, the content selection engine 218 can identify strategies to apply for the selection and arrangement of content to include in a user interface 103 presented to a user. The user context can be based on a variety of factors including, for example, store brand, store type (e.g., physical vs. online), location, region, user eligibility status (e.g., membership status, included in an invite-only list, etc.), current store section (e.g., what product categories or aisle is the user currently browsing), type of page the customer is reviewing (e.g., item detail page, store front page, search result page, etc.), user interaction history (e.g., purchase history, browsing history, viewing history, search history, rating history, etc.), interaction behavior during an active shopping experience (e.g., searching behavior, browsing behavior, and add to cart behavior), aggregate interaction behavior (e.g., multiple users interaction behavior), item availability (e.g., inventory, delivery capacity), event notice (e.g., emergency, road closure, etc.), time (e.g., date, year, week, day), seasonality, a predefined list of items associated with a user account, user-defined positions for select aisles 109, and/or other factors.

In addition, the content selection engine 218 can rank and determine the arrangement of content (e.g., aisles 109) according to the user-defined positions for one or more aisles 109, the user context, content personalization models 230, and/or other factors and models as can be appreciated.

The data stored in the data store 212 includes, for example, user data 221, an item catalog 224, content personalization models 230, network content data 233, and potentially other data. The user data 221 includes various data collected from or generated by users and/or customers having accounts in an electronic commerce site facilitated by the electronic commerce application 215. The user data 221 may include interaction history data 236, preference data 239, account address(es), payment instrument data, authentication information, and/or other data associated with a user or user account of the electronic commerce site.

The interaction history data 236 may include information specific to a user account such as, for example, a purchase history (including purchase frequency, purchase cadence, purchase recency, etc.), a browsing history, a viewing history, a rating history, a search history, and/or other information that reflects a prior interaction by the user account with the computing environment 203.

The preference data 239 may include information related to preferences of items, item attributes, brands of items, quality of items, quantity of items, and/or other information. In addition, the preference data 239 can include user-defined positions for one or more aisles 109. For example, the preference data 239 can indicate that a given aisle 109 is to be included in a first display region 115 designated for selected aisles 109. In other examples, the preference data 239 can indicate a preferred “slot” in a user interface layout.

The item catalog 224 includes item data 242 regarding items offered through the electronic commerce application 215. Such items may include products, goods, services, digital content, and/or other items that can be offered for sale, lease, rent, download, etc. The items in the item catalog 224 may be organized according to a taxonomy of categories. For example, the items in the item catalog 224 may be categorized according to an item type with various item attributes further defining a placement of an item in the taxonomy. For example, milk and cheese can include two branches of the taxonomy under a category for “dairy.” Further, the category associated with milk, for example, may further include branches according to type, flavoring, fat percentage, organic features, and so on.

The item data 242 may include item attributes, an item identifier, descriptions, weights, prices, quantities available, export restrictions, customer reviews, customer ratings, images, videos, version information, availability information, shipping information, and/or other data. Item attributes can include specific characteristics that define a given item. For example, item attributes can include size, color, weight, packaging, quantity, freshness, ripeness, nutritional values, how the item is processed, brand, seasonality (e.g., fall, winter, spring, summer, holidays, etc.), associated activities (e.g., celebration, weddings, picnics, sporting events, etc.), hazardous classification, fragility, import/export restrictions, and/or other attributes as can be appreciated.

The content personalization models 230 include rules, models, and/or configuration data for the various algorithms or approaches employed by the content selection engine 218. For example, the content personalization models 230 can include the various models and/or algorithms for ranking and determining an order of presentation for the various types of content to be included in a user interface. In some examples, the content personalization models 230 can be used to generate scores for the different aisles 109 to present to the user, according to the user context. In addition, the content personalization models 230 can be used to generate scores for the different aisle 109. The calculated scores can be ranked and used to determine an order of presentation of the content (e.g., aisle 109) included in a given user interface 103. The content personalization models 230 can further be used to integrate the user-defined positions for certain content with the dynamic ranking of content such that the user-defined position for a given content supersedes the automatically determined ranking of the given content.

The network content data 233 may include various data employed by the electronic commerce application 215 and/or the content selection engine 218 in generating user interfaces 103, and/or other network pages. The network content data 233 may include hypertext markup language (HTML), extensible markup language (XML), cascading style sheets (CSS), images, text, audio, video, templates, and/or other data.

The client device 206 is representative of a plurality of client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The client device 206 may include a display 248. The display 248 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 249 and/or other applications. The client application 249 may be executed in a client device 206, for example, to access network content served up by the computing environment 203 and/or other servers, thereby rendering a user interface 103 on the display 248. To this end, the client application 249 may comprise, for example, a browser, a dedicated application, etc., and the user interface 103 may comprise a network page, an application screen, etc. The client device 206 may be configured to execute applications beyond the client application 249 such as, for example, email applications, social networking applications, word processors, spreadsheets, and/or other applications.

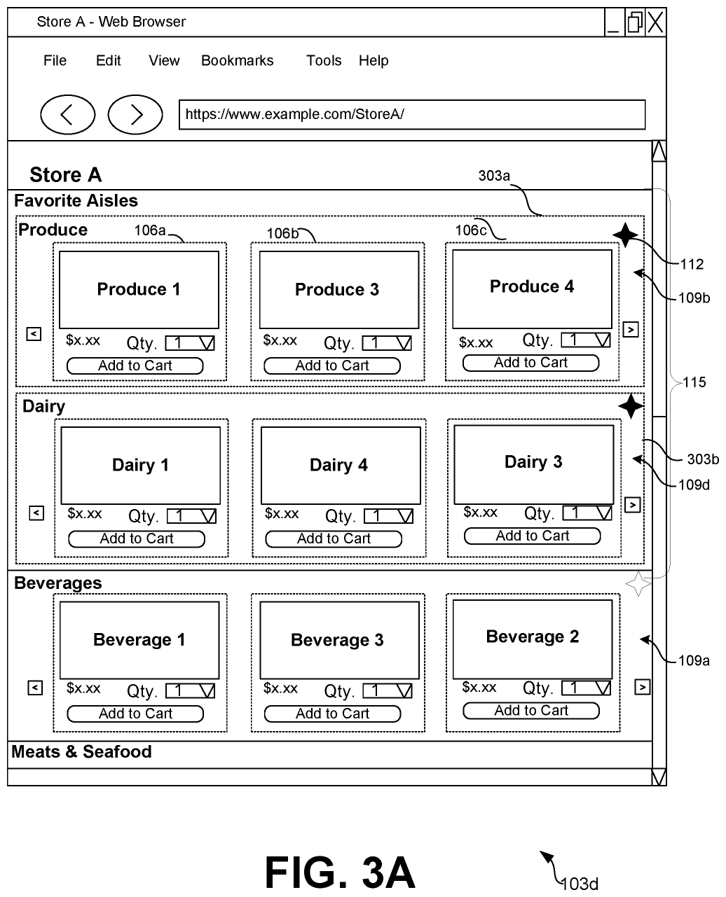

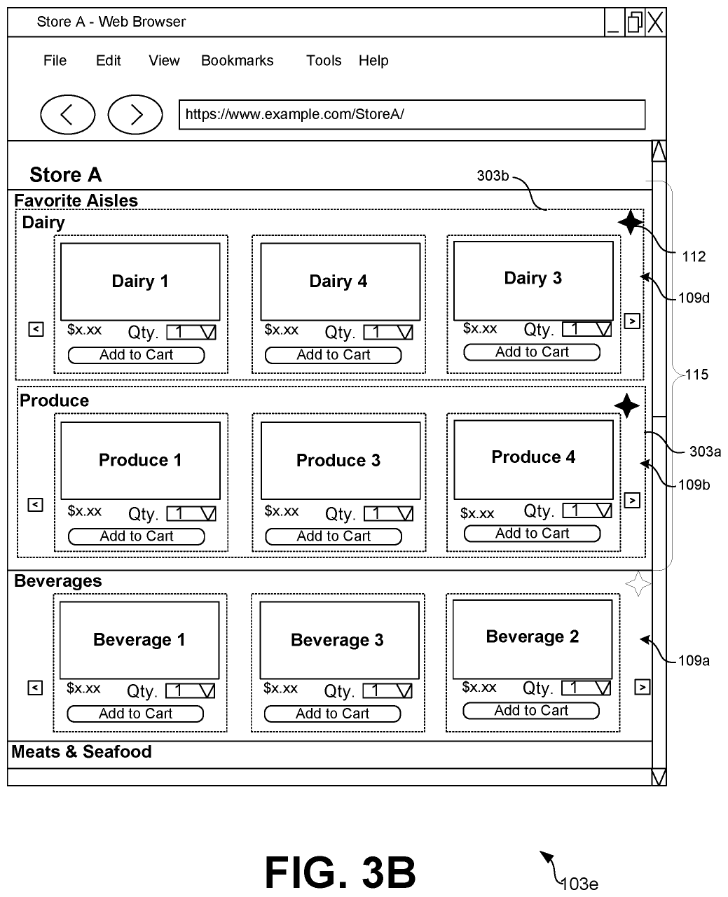

Referring next to FIG. 3A, shown is an example user interface 103d that includes a first display region 115 including aisles 109 or other content that have been selected via selection of a corresponding selectable component 112 for placement in the first display region 115. As discussed with respect to FIGS. 1A and 1C, a selection of the selectable component 112 can indicate a request by the user account to position the selectable component 112 in the first display region 115. In the example of FIG. 3A, the selectable components 112 corresponding to aisles 109b, 109d have been previously selected via user interaction by the user account. As such, the aisles 109b, 109d are included in the first display region 115 of the user interface 103. According to various examples, the aisles 109b, 109d can be arranged in the first display region 115 according to the ranking of the aisles 109 based at least in part on a user context and/or a strategy such that the aisle 109 considered to be most relevant to the user account is displayed above an aisle 109 of lower relevancy.

According to various embodiments, an aisle 109 comprises a user interface element 303 (e.g. 303a, 303b) that can be configured to be movable in the user interface 103 relative to other user interface elements 303 via user interaction (e.g., dragging interaction). For example, in the example of FIG. 3A, a user can select a region defined by the user interface element 303a and “drag” the user interface element to a different position relative to the user interface element 303b. FIG. 3B illustrates a user interface 103e that shows the user interface element 303a associated with “Produce” moved to a position in the first display region 115 that, in contrast to FIG. 3A, is below the user interface element 303b according to various examples of the present disclosure. As such, the user is able to modify and define the arrangement of the content that is presented during his or her shopping experience. Although the ability to adjust the arrangement of user interface elements 303 via user interaction (e.g., dragging interaction) is discussed and illustrated with respect to user interface elements 303 that correspond to aisles 109 selected to be positioned within the first display region 115, it should be noted that in various embodiments, a user interface 103 can be configured to allow a user-defined arrangement via similar user interaction in any area of the user interface layout. For example, referring back to the example of FIG. 1A, the arrangement of the aisles 109 can be similarly rearranged by the user via a dragging user interaction.

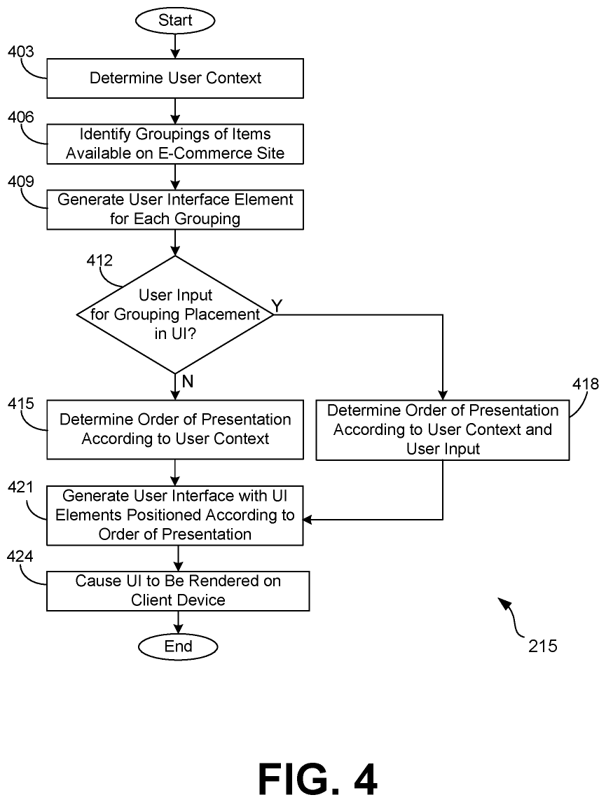

Referring next to FIG. 4, shown is a flowchart that provides one example of the operation of portions of the electronic commerce application 215 and the content selection engine 218, according to various embodiments. It is understood that the flowchart of FIG. 4 provides merely an example of the many different types of functional arrangements that may be employed to implement the operation of the portions of the electronic commerce application 215 and the content selection engine 218, as described herein. As an alternative, the flowchart of FIG. 4 may be viewed as depicting an example of elements of a method implemented in the computing environment 203 (FIG. 2) according to one or more embodiments.

Beginning with box 403, the content selection engine 218 determines a user context associated with a user session of a user interacting with the electronic commerce application 215. The user context can be based on a variety of factors such as for example, store brand, store type (e.g., physical vs. online), location, region, user eligibility status (e.g., membership status, included in an invite-only list, etc.), current store section (e.g., what product categories or aisle is the user currently browsing), type of page the customer is reviewing (e.g., item detail page, store front page, search result page, etc.), user interaction history (e.g., purchase history, browsing history, viewing history, search history, rating history, etc.), interaction behavior during active shopping experience (e.g., searching behavior, browsing behavior, and add to cart behavior), item availability (e.g., inventory, delivery capacity), event notice (e.g., emergency, road closure, etc.), time (e.g., date, year, week, day), seasonality, a predefined list of items associated with a user account, one or more user-specified content positions, and/or other factors. It should be noted that some of the factors can be static (e.g., store brand, store location, user eligibility status, etc.) while other of the factors can be dynamic (e.g., interaction behavior, user interaction history, time, etc.).

According to various embodiments, the content selection engine 218 may apply the content personalization models 230 to identify or otherwise generate a user context based on an analysis of the factors. In some examples, the content selection engine 218 can select items from the item catalog 224 that may be of interest or otherwise relevant to the user based on the analysis of the various factors and the generated user context.

At box 406, the content selection engine 218 identifies groupings of items available for purchase, lease, rent, download, etc. through the electronic commerce application 215. For example, the groupings of items may correspond to different categories of items as defined by the taxonomy of the item catalog 224. In this example, the groupings of items may correspond to “dairy items,” “produce items,” “beverages,” “snacks,” etc. In some examples, items that may not be included in a given category but are considered to be a complementary item to an item in a given category may still be included in a particular grouping of items. In another example, an item that may be on sale may be selected to be part of a grouping even though the item may not be associated with a particular item category.

The content selection engine 218 can further identify items for the grouping according to the user context and/or strategies. For example, the grouping may correspond to a given category or subcategory identified in the taxonomy of the item catalog 224. As such, items belonging to the category or subcategory that are determined to be of interest to the user according to the user context may be selected to be included in the grouping. In addition, items belonging to a particular category and being associated with a given strategy (e.g., a previously purchased item) can be selected to be included in the item grouping in association with the given strategy.

At box 409, the content selection engine 218 generates a user interface element 303 for each of the identified groupings. The user interface element 303 can correspond to an object or container in a user interface 103 and can include the item listings 106 associated with the selected items. The item listings 106 are arranged in the user interface element 303 according to the determined order of presentation such that the user sees the items determined to be of greatest relevance and/or interest prior to the items determined to be of least relevant and/or interest. According to various embodiments, the user interface element 303 can comprise an aisle 109 or other type of content.

According to various examples, each user interface element 303 is generated to include a selectable component 112 (e.g., link, button, image, icon, etc.) and/or other user interface component that allows a user account to request a preferred location of a given user interface element 303 within a user interface layout 303 via user interaction. For example, a selection of the selectable component 112 may indicate a request to have the given user interface element 303 remain in a static position in the user interface. In another examples, a selection of the selectable component 112 may indicate a request to have the user interface element 303 included in a particular display region 115 that is designated for user interface elements 303 associated with a selected selection component 112.

In some examples, the user interface element 303 can be generated such that user interaction with a predefined region defining the user interface element 303 can allow rearrangement of the user interface element 303 in the user interface 103 relative to other user interface elements 303. For example, the user interface element 303 can be generated to accommodate a dragging interaction such that when a user selects the user interface element 303 within the predefined area, the user can “drag” the user interface element 303 to another location within the user interface 103.

At box 412, the content selection engine 218 determines if a user input has been received with respect to a user-defined placement of a given item grouping (e.g., aisle 109). In particular, the content selection engine 218 can determine if the user has previously selected a selection component 112 associated with the item grouping in prior interactions with the electronic commerce site. If the user has previously indicated a user-defined placement of a given item grouping via a user interaction, the content selection engine 218 proceeds to box 418. Otherwise, the content selection engine proceeds to box 415.

At box 415, the content selection engine 218 determines an order of presentation of the item groupings according to the user context and/or strategies. According to various embodiments, the content selection engine 218 can use the content personalization models 230 to determine a score for the different types of identified groupings. For example, the content personalization models 230 may include weights that can be assigned to various groupings and/or user context factors to determine a score for the individual groupings. To further this example, for a given user account assume that the user associated with the user account is a vegetarian and rarely purchases items in a grouping for meats. As such, based on knowledge about the user, the score associated with grouping associated with meat may be lower than a score associated with a grouping associated with produce. According to various embodiments, the different identified groupings of items can be ranked according to an assigned score. The order of presentation of the item groupings can be determined from the generated rankings such that the highest ranked item grouping is presented above lower-ranked item groupings.

At box 418, the content selection engine 218 determines an order of presentation of the item groupings according to the user input, the user context and/or strategies. As discussed in box 415, the content selection engine 218 can use the content personalization models 230 to determine a score for the different types of identified groupings. According to various embodiments, the different identified groupings of items can be ranked according to an assigned score. The order of presentation of the item groupings can be determined from the generated rankings and the user input specifying a particular location for an item grouping in a user interface 103. Typically, the highest ranked item grouping is presented above lower-ranked item groupings as discussed in box 415. However, in situations where a user account has specified that a particular item grouping is to be included in a first display region 115 or in a particular slot that contradicts the location of the item grouping based on the generated ranking, the content selection engine 218 can adjust the order of presentation to include the user-defined position(s).

At box 421, the electronic commerce application 215 generates a user interface 103 with the generated user interface elements. The user interface elements are arranged within the user interface 103 according to the determined order of presentation from box 415 or box 418. As such, the user interface element corresponding to the higher ranked grouping of items is displayed at a higher level (e.g., top of the page) on the user interface 103 than a lower ranked grouping of items unless a user account has specified a particular location for a given item grouping. The user interface 103 can correspond to an item detail page, a search results page, a store landing page, an aisle landing page, and/or other type of page associated with the electronic commerce application 215 that includes listings of items available via the electronic commerce application 215.

At box 424, the electronic commerce application 215 causes the user interface 103 to be rendered on the client device 206. For example, the electronic commerce application 215 may transmit user interface code that can be executed by the client application 249 to generate and render the user interface 103 on the client device 206. In other examples, the electronic commerce application 215 can transmit the generated user interface 103 to the client device 206 for rendering. For example, the electronic commerce application 215 can send data associated with the generated user interface 103 in response to an application programming interface (API) call from the client application 249. Thereafter, this portion of the process proceeds to completion.

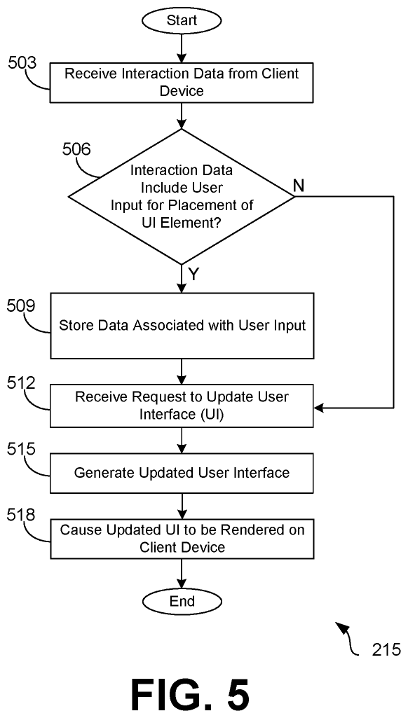

Referring next to FIG. 5, shown is a flowchart that provides one example of the operation of portions of the electronic commerce application 215 and the content selection engine 218, according to various embodiments. It is understood that the flowchart of FIG. 5 provides merely an example of the many different types of functional arrangements that may be employed to implement the operation of the portions of the electronic commerce application 215 and the content selection engine 218, as described herein. As an alternative, the flowchart of FIG. 5 may be viewed as depicting an example of elements of a method implemented in the computing environment 203 (FIG. 2) according to one or more embodiments.

Beginning with box 503, the electronic commerce application 215 receives interaction data from the client device 206 with regard to a user account interacting with a user interface 103 of the electronic commerce application 215. The user interactions can include selection actions, scrolling actions, hovering actions, purchasing actions (e.g., adding to cart, one-click purchases), browsing actions, and/or other type of interactions that can be appreciated. The interaction data can be received in real-time, periodically, or randomly.

At box 506, the electronic commerce application 215 determines if the interaction data includes a user input regarding a placement of a particular user interface element 303. For example, an interaction can correspond to a selection or deselection of a selectable component 112. Another example of an interaction can include a dragging interaction requesting movement of a user interface element 303 to a different position on the user interface 103. If a user input associated with the positioning of a user interface element 303 is included in the user interaction data, the electronic commerce application 215 proceeds to box 509. Otherwise, the electronic commerce application 215 proceeds to box 512.

At box 509, the electronic commerce application 215 stores the user interaction data specifying the user input in the preference data 239 of the data store 212. In particular, the user input can be used to generate the user context and/or strategies used to select and organize content in a user interface 103 for one or more user accounts. In addition, the user input can be used in generating user interfaces 103 that included the specified arrangement of content (e.g., aisles 109) as defined by a user account.

At box 512, the electronic commerce application 215 receives a request from the client device 206 to update the user interface 103 rendered on the client device 206. For example, the update can be in response to a user interaction with the user interface 103 causing the user interface 103 to refresh. In other examples, the update can be in response to a selection of a user interface component that upon selection redirects the user to a different type of user interface 103 (e.g., item detail page, past purchases page, search results page, etc.).

At box 515, the electronic commerce application 215 generates an updated user interface 103. In particular, as discussed in FIG. 4, the user context can be determined based on the updated user interactions. In addition, the item groupings can be identified and the user interface elements 303 can be generated based at least in part on the user context and any user input received that specifies a particular position in the user interface 103 for a given user interface element 303. The user interface elements 303 can be arranged within the user interface 103 according to the determined order of presentation. The user interface 103 can correspond to an item detail page, a search results page, a store landing page, an aisle landing page, and/or other type of page associated with the electronic commerce application 215 that includes listings of items available via the electronic commerce application 215.

At box 518, the electronic commerce application 215 causes the user interface 103 to be rendered on the client device 206. For example, the electronic commerce application 215 may transmit user interface code that can be executed by the client application 249 to generate and render the user interface 103 on the client device 206. In other examples, the electronic commerce application 215 can transmit the generated user interface 103 to the client device 206 for rendering. For example, the electronic commerce application 215 can send data associated with the generated user interface 103 in response to an application programming interface (API) call from the client application 249. Thereafter, this portion of the process proceeds to completion.

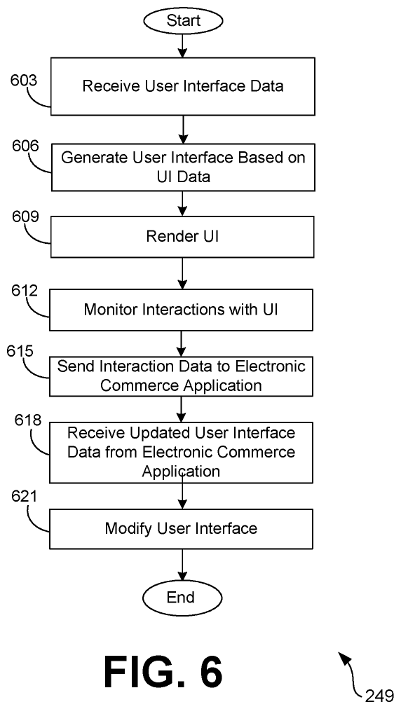

Referring next to FIG. 6, shown is a flowchart that provides one example of the operation of a portion of the client application 249, according to various embodiments. It is understood that the flowchart of FIG. 6 provides merely an example of the many different types of functional arrangements that may be employed to implement the operation of the portion of the client application 249, as described herein. As an alternative, the flowchart of FIG. 6 may be viewed as depicting an example of elements of a method implemented in the client device 206 (FIG. 2) according to one or more embodiments.

Beginning with box 603, the client application 249 receives user interface data and user interface code that is executable by the client application 249. The client application 249 receives the user interface data and user interface code from the electronic commerce application 215 or other appropriate application in the computing environment 203. In some examples, the client application 249 may receive the user interface data and/or the user interface code in response to an API call to the electronic commerce application 215 for the user interface data for generating user interfaces 103 associated with the electronic commerce application 215.

At box 606, the client application 249 generates a user interface 103 based on the user interface data received from the electronic commerce application 215. For example, the client application 249 can execute the user interface code to generate the user interface 103 as defined by the user interface code and defined by the electronic commerce application 215 and/or the content selection engine 218.

At box 609, the client application 249 causes the user interface 103 to be rendered by the client device 206. As such, the user interface 103 can be displayed to the user associated with the client device 206 interacting with the electronic commerce application 215.

At box 612, the client application 249 monitors user interactions with the user interface 103 rendered on the client device 206. The interactions can include selection actions, scrolling actions, hovering actions, purchasing actions (e.g., adding to cart, one-click purchases), browsing actions, and/or other type of interactions that can be appreciated. For example, an interaction can correspond to a selection or deselection of a selectable component 112. Another example can include a dragging interaction requesting movement of a user interface element 303 to a different position on the user interface 103. The client application 249 can generate interaction data based on the user interactions and at box 615, the client application can send the interaction data to the electronic commerce application 215. The interaction data can be sent to the electronic commerce application 215 in real-time, periodically, or randomly.

At box 618, the client application 249 can receive user interface data from the computing environment 203 in response to sending the user interaction data. The user interface data can include data associated with a modified user interface 103 based at least in part on a detected change in the user context due to the monitored user interactions. The user interface data can also include data for generating an additional user interface 103, modifying the arrangement of content in a rendered user interface 103, and/or other types of data.

At box 621, the client application 249 can modify the user interface 103 based on the received user interface data. For example, the client application 249 can execute the user interface code to generate the modified user interface 103 as defined by the user interface code and defined by the electronic commerce application 215 and/or the content selection engine 218. Upon modifying the user interface 103, the client application 249 causes the modified user interface 103 to be rendered by the client device 206. Thereafter, this portion of the process proceeds to completion.

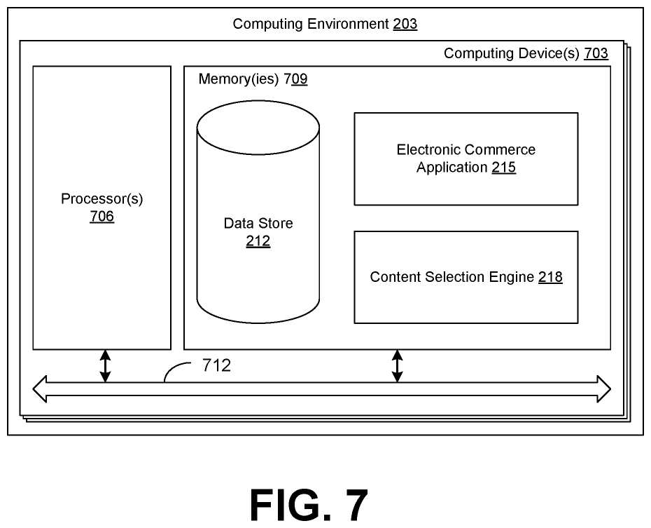

With reference to FIG. 7, shown is a schematic block diagram of the computing environment 203 according to an embodiment of the present disclosure. The computing environment 203 includes one or more computing devices 703. Each computing device 703 includes at least one processor circuit, for example, having a processor 706 and a memory 709, both of which are coupled to a local interface 712. To this end, each computing device 703 may comprise, for example, at least one server computer or like device. The local interface 712 may comprise, for example, a data bus with an accompanying address/control bus or other bus structure as can be appreciated.

Stored in the memory 709 are both data and several components that are executable by the processor 706. In particular, stored in the memory 709 and executable by the processor 706 are the electronic commerce application 215, the content selection engine 218, and potentially other applications. Also stored in the memory 709 may be a data store 212 and other data. In addition, an operating system may be stored in the memory 709 and executable by the processor 706.

It is understood that there may be other applications that are stored in the memory 709 and are executable by the processor 706 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 709 and are executable by the processor 706. In this respect, the term “executable” means a program file that is in a form that can ultimately be run by the processor 706. Examples of executable programs may be, for example, a compiled program that can be translated into machine code in a format that can be loaded into a random access portion of the memory 709 and run by the processor 706, source code that may be expressed in proper format such as object code that is capable of being loaded into a random access portion of the memory 709 and executed by the processor 706, or source code that may be interpreted by another executable program to generate instructions in a random access portion of the memory 709 to be executed by the processor 706, etc. An executable program may be stored in any portion or component of the memory 709 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 709 is defined herein as including both volatile and nonvolatile memory and data storage components. Volatile components are those that do not retain data values upon loss of power. Nonvolatile components are those that retain data upon a loss of power. Thus, the memory 709 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 706 may represent multiple processors 706 and/or multiple processor cores and the memory 709 may represent multiple memories 709 that operate in parallel processing circuits, respectively. In such a case, the local interface 712 may be an appropriate network that facilitates communication between any two of the multiple processors 706, between any processor 706 and any of the memories 709, or between any two of the memories 709, etc. The local interface 712 may comprise additional systems designed to coordinate this communication, including, for example, performing load balancing. The processor 706 may be of electrical or of some other available construction.

Although the electronic commerce application 215, the content selection engine 218, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 4-6 show the functionality and operation of an implementation of portions of the electronic commerce application 215, the content selection engine 218, and the client application 249. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 706 in a computer system or other system. The machine code may be converted from the source code, etc. If embodied in hardware, each block may represent a circuit or a number of interconnected circuits to implement the specified logical function(s).

Although the flowcharts of FIGS. 4-6 show a specific order of execution, it is understood that the order of execution may differ from that which is depicted. For example, the order of execution of two or more blocks may be scrambled relative to the order shown. Also, two or more blocks shown in succession in FIGS. 4-6 may be executed concurrently or with partial concurrence. Further, in some embodiments, one or more of the blocks shown in FIGS. 4-6 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the electronic commerce application 215, the content selection engine 218, and the client application 249, that comprises software or code can be embodied in any non-transitory computer-readable medium for use by or in connection with an instruction execution system such as, for example, a processor 706 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the electronic commerce application 215, the content selection engine 218, and the client application 249, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 703, or in multiple computing devices 703 in the same computing environment 203.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, wherein when executed the program causes the at least one computing device to at least:
identify a user context associated with a user account interacting with an electronic commerce site;
identify a plurality of item groupings based at least in part on the user context;
determine a user-specified position for a particular item grouping of the plurality of item groupings in a user interface;
determine an order of placement for a plurality of user interface elements in the user interface based at least in part on a ranking of the plurality of user interface elements and the user-specified position, the plurality of user interface elements being associated with the plurality of item groupings, and the ranking of the plurality of user interface elements being based at least in part on the user context;
generate the user interface according to the order of placement of the plurality of user interface elements, wherein individual user interface elements of the plurality of user interface elements include a respective selectable component, that upon user selection, causes a respective user interface element to be displayed in a respective user-specified position in the user interface relative to other user interface elements of the plurality of user interface elements in response to a refresh of the user interface, the respective user-specified position superseding a ranked position of the respective user interface element; and
cause the user interface to be rendered on a client device.

2. The non-transitory computer-readable medium of claim 1, wherein the user interface comprises a first display region and at least one second display region, the user-specified position being in the first display region, and one or more user interface elements of the plurality of user interface elements that are associated with a non-selected selectable component are positioned within the at least one second display region.

3. The non-transitory computer-readable medium of claim 2, wherein the first display region comprises a subset of the user interface elements of the plurality of user interface elements, the user interface being configured to allow reordering of individual user interface elements in the subset of the plurality of user interface elements relative to one another via user interaction.

4. The non-transitory computer-readable medium of claim 1, wherein the user context is based at least in part on at least one of a brand of an entity associated with the electronic commerce site, a client device location, an entity location, a user eligibility status, a particular item grouping, a type of user interface, a user interaction history, an aggregate user interaction history, an item availability, an occurrence of an event, a time, a date, a predefined list of items associated with the user account, or a seasonality.

5. A system, comprising:
at least one computing device; and
at least one application executable in the at least one computing device, wherein when executed the at least one application causes the at least one computing device to at least:
identify a plurality of item groupings based at least in part on a user context;
determine an order of placement for a plurality of user interface elements in a user interface based at least in part on the user context and a user-specified position for a specific user interface element of the plurality of user interface elements, the plurality of user interface elements being associated with the plurality of item groupings;
generate the user interface according to the order of placement of the plurality of user interface elements, wherein individual user interface elements of the plurality of user interface elements include a selectable component, that upon user interaction, causes a respective user interface element to be displayed in a respective user-specified position in the user interface relative to other user interface elements of the plurality of user interface elements in response to a refresh of the user interface; and
cause the user interface to be rendered on a client device.

6. The system of claim 5, wherein, when executed, the at least one application causes the at least one computing device to at least:
receive user interface data from the client device indicating a selection of a particular selectable component of a particular user interface element; and
store the user interface data in a data store, the user interface data being a factor for at least determining an updated user context.

7. The system of claim 6, wherein, when executed, the at least one application causes the at least one computing device to at least generate a modified user interface based at least in part on the updated user context and the selection of the particular selectable component.

8. The system of claim 7, wherein the plurality of user interface elements of the modified user interface are arranged such that the particular user interface element is displayed in the respective user-specified position and the other user interface elements are rearranged according to the updated user context.

9. The system of claim 5, wherein the respective user-specified position comprises a static position such that a respective user interface element remains in a same position in the user interface in response to the refresh of the user interface while an arrangement of one or more other user interface elements in the user interface changes.

10. The system of claim 5, wherein the user interface includes a first display region and at least one second display region, the user-specified position is in the first display region, and prior to selection of the selectable component, the respective user interface element is displayed in the at least one second display region.

11. The system of claim 10, wherein the first display region comprises a first user interface element in a first position and a second user interface element in a second position, and the user interface is configured such that a user interaction within the first display region causes a user-specified change of at least one of the first position or the second position.

12. The system of claim 5, wherein the user interaction comprises a dragging action.

13. The system of claim 5, wherein when executed, the at least one application causes the at least one computing device to at least determine the user context associated with a user account interacting with an electronic commerce application.

14. A method, comprising:
receiving, by a client device, user interface data from at least one computing device associated with an electronic commerce site;
dynamically generating, by the client device, a user interface based at least in part on the user interface data, the user interface comprising a plurality of user interface elements corresponding to a plurality of item groupings arranged in an order based at least in part on a user context, individual user interface elements comprising a respective selectable component configured to cause a respective user interface element to be displayed in a specific position relative to other user interface elements in response to a refresh of the user interface; and
rendering, by the client device, the user interface via a display of the client device.

15. The method of claim 14, further comprising:
identifying, by the client device, a user selection of a particular selectable component for a particular user interface element of the plurality of user interface elements; and
sending, by the client device, interaction data including the user selection of the particular selectable component to the at least one computing device.

16. The method of claim 15, wherein the user interface comprises a first user interface, and the method further comprises:
receiving, by the client device, a request to refresh the first user interface;
obtaining, by the client device, updated user interface data based at least in part on the interaction data and an updated user context; and
generating, by the client device, a second user interface based at least in part on the updated user interface data, wherein the particular user interface element is positioned in the second user interface at the specific position.

17. The method of claim 16, wherein a first arrangement of the other user interface elements in the first user interface differs from a second arrangement of the other user interface elements in the second user interface.

18. The method of claim 14, wherein the plurality of item groupings are further arranged according to at least one selection of the respective selectable component for at least one of the plurality of user interface elements.

19. The method of claim 14, wherein the user interface comprises a first region and at least one second region, and the specific position being within the first region, and user interface elements comprising a selected selectable component being positioned within the first region and user interface elements comprising an unselected selectable component being positioned within the at least one second region of the user interface.

20. The method of claim 19, wherein a subset of the user interface elements of the plurality of user interface elements are included in the first region, and the method further comprises:
receiving, by the client device, a user interaction requesting a reordering of a first user interface element in the subset of the user interface elements with respect to a second user interface element in the subset of the user interface elements; and
modifying, by the client device, the user interface based at least in part on the user interaction such that a respective position of the first user interface element and the second user interface element are changed according to the reordering.
